(19) United States
(12) Patent Application Publication
(10) Pub. No.: US 2002/0162424 A1
(43) Pub. Date: Nov. 7, 2002

(54) Wrench with a simplified structure

(76) Inventor: Bobby Hu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/142,001

(22) Filed: May 8, 2002

Related U.S. Application Data
(63) Continuation-in-part of application No. 09/850,285, filed on May 7, 2001.

(51) Int. Cl. B25B 13/46

(52) U.S. Cl. 81/60

(57) ABSTRACT

A wrench includes a handle, a head extended from the handle, and a drive member rotatably mounted in a compartment of the head. A cavity is defined in a web between the handle and the head and communicated with the compartment. A transverse hole is defined in the web and includes an inner end communicated with the cavity and an outer end communicated with outside. A pawl is slidably mounted in the cavity and includes a toothed side, an attachment side, and a pressing side. An elastic element includes a first end attached to the attachment side of the pawl and a second end attached to an anchor securely mounted in the transverse hole. The toothed side of the pawl is biased to engage with the drive member and the pressing side of the pawl is biased to press against a wall defining the cavity.

### CROSS REFERENCE TO RELATED APPLICATION

This is a continuation-in-part application of U.S. patent application Ser. No. 09/850,285 filed on May 7, 2001, which is now abandoned.

### BACKGROUND OF THE INVENTION

1. Field of the Invention

The present invention relates to a wrench with a simplified structure.

2. Description of the Related Art

U.S. Pat. No. 5,636,557 to Ma issued on Jun. 10, 1997 discloses a ratchet type ring spanner comprising a handle and a head portion extended from the handle. The head portion includes a circular peripheral wall defining a receiving compartment therein and a web area connected with the handle. A ratchet wheel is received in the compartment. An arcuate toothed member is mounted in a cavity defined in the web area and includes teeth on a side thereof for engaging with the teeth in an outer periphery of the ratchet wheel. A stop member is mounted in the cavity and includes an end bearing against the wall defining the cavity. A spring is mounted between the stop member and the toothed member to bias the toothed member away from the stop member. However, the wall defining the cavity must be processed to provide a depression for securely receiving a U-shape anchor of the stop member. The stop member and two wings on the stop member must be configured to correspond with the depression. These increase difficulty in manufacture, and there is a risk of disengagement of the anchor from the depression. The overall structure is complicated and the manufacture cost is relatively high. In operation, the wings of the stop member slide for a distance when the arcuate toothed member is driven by the ratchet wheel. It was, however, found that the wings tend to break, as the area of the wings subject to force is relatively small. In addition, the anchor tends to be carried away by the wings and is thus disengaged from the depression, which results in malfunction of the spanner.

### SUMMARY OF THE INVENTION

It is the primary object of the present invention to provide an improved wrench with a simplified structure to thereby save the cost and time for assembly.

It is another object of the present invention to provide an improved wrench with a simplified structure, wherein malfunction resulting from sticking of the pawl to the drive member of the wrench is prevented.

A wrench in accordance with the present invention comprises:

a handle;

a head extended from the handle and including a compartment, a web being defined between the handle and the head, a cavity being defined in the web and communicated with the compartment, a transverse hole being defined in the web and including an inner end communicated with the cavity and an outer end communicated with outside;

a drive member rotatably mounted in the compartment and including a plurality of teeth on an outer periphery thereof;

a pawl slidably mounted in the cavity and including a toothed side, an attachment side, and a pressing side;

an anchor securely mounted in the transverse hole; and

an elastic element including a first end attached to the attachment side of the pawl and a second end attached to the anchor, the pawl being biased by the elastic element such that the toothed side of the pawl is biased to engage with the teeth of the drive member and that the pressing side of the pawl is biased to press against with a wall defining the cavity.

The anchor includes an embossed end for frictional engagement with an inner periphery defining the transverse hole. The attachment side of the pawl includes a peg to which the first end of the elastic element is attached. In a case that the pawl is stuck to the drive member, the peg is impinged by another end of the anchor when the handle is turned in a free rotating direction and thus causes disengagement of the pawl from the drive member.

In an embodiment of the invention, the drive member includes a protruded portion on a top thereof. A ring cap is mounted around the protruded portion and includes an annular groove in an outer periphery thereof. An inner periphery defining the compartment of the head includes an upper portion with an annular groove. A C-clip is engaged in the annular groove of the protruded portion of the drive member and the annular groove of the head, thereby rotatably mounting the drive member in the compartment of the head. The inner periphery defining the compartment of the head includes an annular ledge projecting inward from a lower portion thereof. The drive member includes an inner periphery for engaging with a fastener. The inner periphery of the drive member includes a plurality of faces, each two adjacent faces having a concave portion therebetween.

In another embodiment of the invention, the anchor includes a flange on an outer periphery thereof and located in the cavity, and the second end of the elastic element is attached to the flange of the anchor.

In a further embodiment of the invention, the anchor includes a protrusion on an outer periphery thereof and located in the cavity, and the second end of the elastic element is attached to the protrusion of the anchor.

In still another embodiment of the invention, the transverse hole is a screw hole, and the anchor includes a threaded section that is threadedly engaged in the screw hole.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a portion of a wrench in accordance with the present invention.

FIG. 2 is an exploded perspective view of the portion of the wrench in FIG. 1.

FIG. 3 is a sectional view of the portion of the wrench in FIG. 1.

FIG. 4 is a sectional view similar to FIG. 3, wherein the wrench rotates freely.

FIG. 5 is a sectional view taken along line 5-5 in FIG. 3.

FIG. 6 is a sectional view similar to FIG. 3, wherein the pawl is stuck to the drive member.

FIG. 7 is a sectional view similar to FIG. 6, wherein the pawl is disengaged from the drive member.

FIG. 8 is an exploded perspective view of a second embodiment of the wrench in accordance with the present invention.

FIG. 9 is a sectional view of the wrench in FIG. 8.

FIG. 10 is a sectional view of a third embodiment of the wrench in accordance with the present invention.

FIG. 11 is an exploded perspective view of a fourth embodiment of the wrench in accordance with the present invention.

FIG. 12 is a sectional view of the wrench in FIG. 11.

### DETAILED DESCRIPTION OF THE PREFERRED EMBODIMENTS

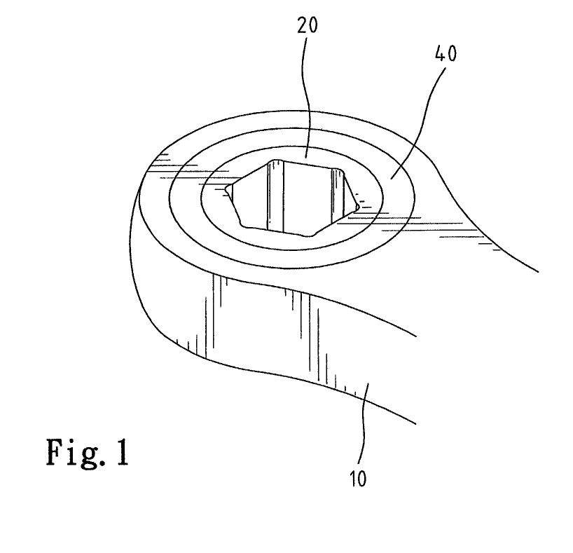

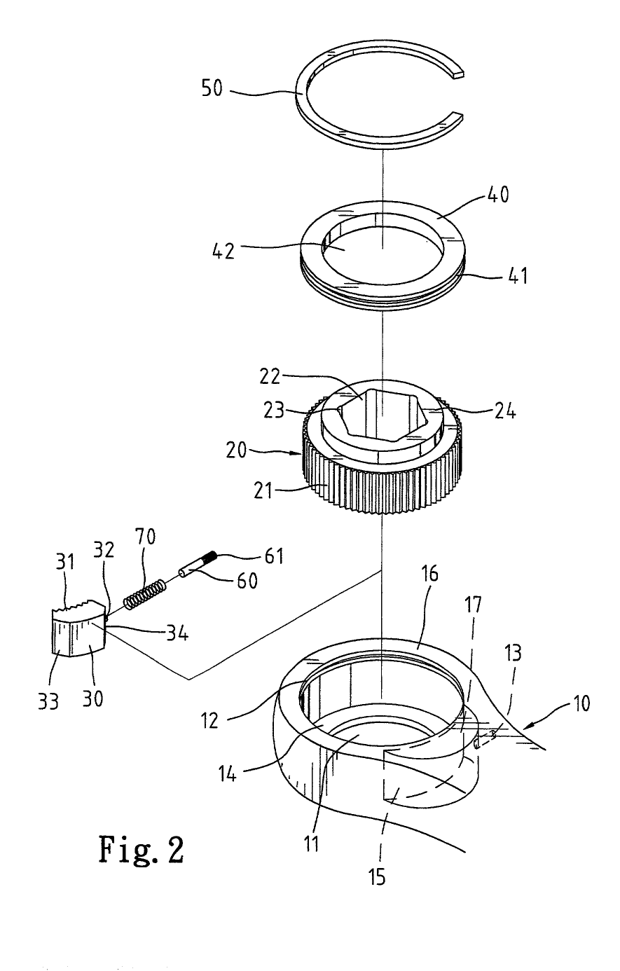

Referring to FIGS. 1 through 7 and initially to FIGS. 1 through 3, a wrench in accordance with the present invention generally includes a handle 10 and a head 16 extended from the handle 10. The head 16 includes a compartment 11. An upper portion of an inner periphery defining the compartment 11 includes an annular groove 12. An annular ledge 14 projects inward from a lower portion of the inner periphery defining the compartment 11. Defined in a web 17 between the handle 10 and the head 16 is a cavity 15 communicated with the compartment 11. In addition, a transverse hole 13 is defined in the web 17 and includes an inner end communicated with the cavity 15 and an outer end communicated with outside.

A drive member 20 is rotatably mounted in the compartment 11 and includes a plurality of teeth 21 on an outer periphery thereof. The drive member 20 further includes a polygonal inner periphery 22 for engaging with a fastener, such as a nut or a bolt head. A concave portion 23 is defined between two adjacent faces of the polygonal inner periphery 22. The concave portion 23 allows easy insertion of the fastener without the risk of deformation of the fastener.

A pawl 30 is mounted in the cavity 15 and includes a toothed side 31 (preferably arcuate) for engaging with the teeth 21 of the drive member 20. The pawl 30 further includes a peg 32 on an attachment side 34 thereof and a pressing side 33 that substantially faces away from the attachment side on which the peg 32 is formed.

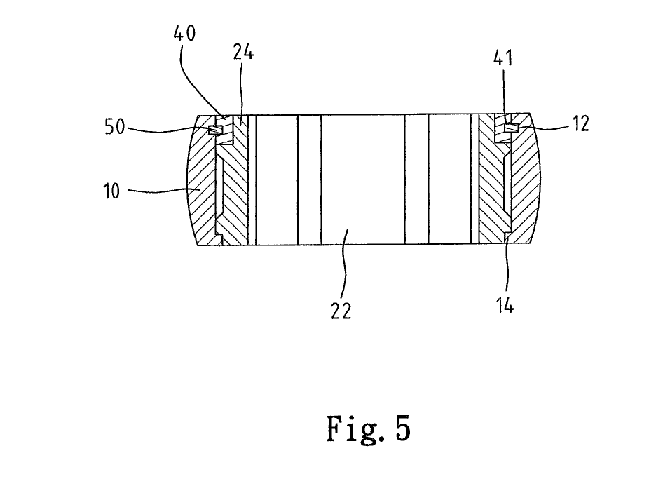

A ring cap 40 is mounted around a protruded portion 24 projecting upward from a top of the drive member 20. The ring cap 40 includes an annular groove 41 in an outer periphery thereof. A C-clip 50 is mounted between the annular groove 12 of the head 16 and the annular groove 41 of the ring cap 40, thereby rotatably mounting the drive member 20 in the compartment 11, best shown in FIG. 5.

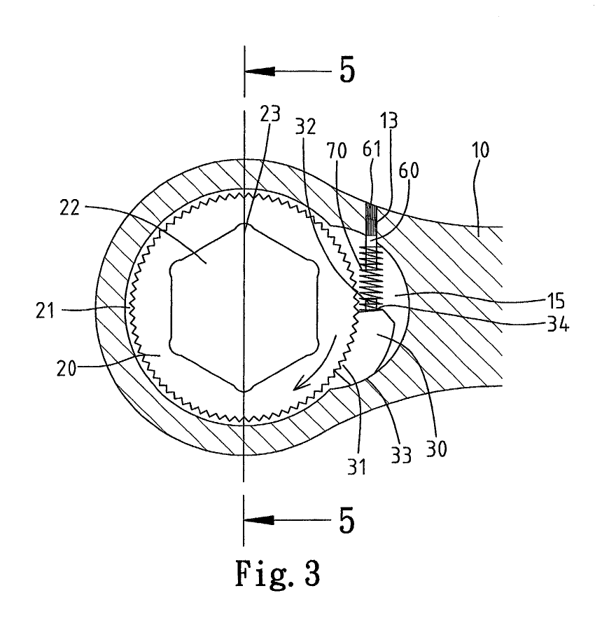

As illustrated in FIG. 3, an anchor 60 is securely mounted in the transverse hole 13. An elastic element 70 includes a first end attached to the peg 32 on the attachment side 34 of the pawl 30 and a second end attached to the anchor 60. An end 61 of the anchor 60 may be embossed to provide increased frictional contact with an inner periphery of the transverse hole 13, thereby retaining the anchor 60 in the transverse hole 13.

In assembly, the first end of the elastic element 70 is attached to the peg 32 on the attachment side 34 of the pawl 30, which is then mounted into the cavity 15. The anchor 60 is inserted into the transverse hole 13 via the embossed end 61 thereof and the second end of the elastic element 70 is attached to the other end of the anchor 60. The C-clip 50 is placed into the annular groove 41 of the ring cap 40, which, in turn, is mounted around the protruded portion 24 of the drive member 20. The drive member 20 is then mounted into the compartment 11 via an upper end of the compartment 11. The annular ledge 14 prevents falling of the drive member 20. The C-clip 50 expands outward and thus engages with the annular groove 12 of the head 16. Thus, assembly of the wrench is completed easily due to the simple structure of the wrench.

Referring to FIG. 3, when the handle 10 is turned clockwise, the pressing side 33 of the pawl 30 presses against a wall defining the cavity 15. The teeth 21 of the drive member 20 reliably mesh with the toothed side 31 of the pawl 30. Thus, the fastener (not shown) engaged in the inner periphery 22 of the drive member 20 is driven clockwise.

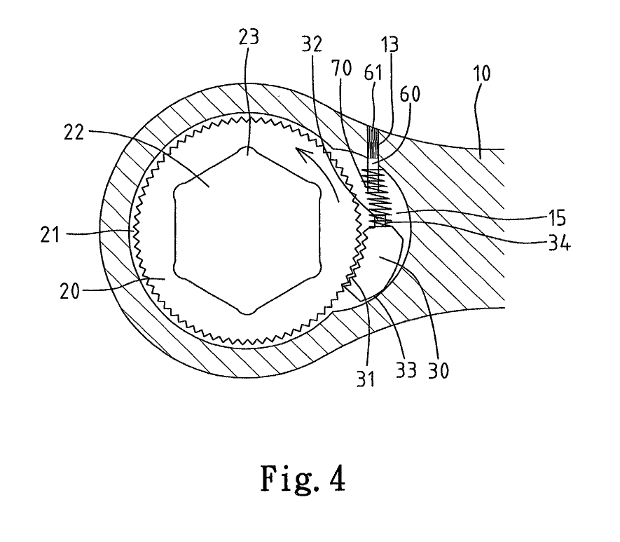

Referring to FIG. 4, when the handle 10 is turned counterclockwise, the force imparted to the pawl 30 causes the pawl 30 to move away from the drive member 20 and to overcome the elastic element 70. The pressing side 33 of the pawl 30 cannot bear against the wall defining the cavity 15. Thus, free rotation occurs when the handle 10 is turned counterclockwise.

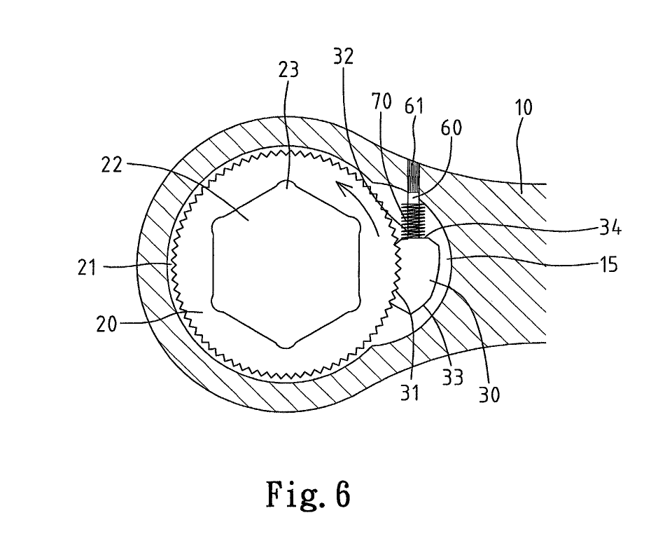

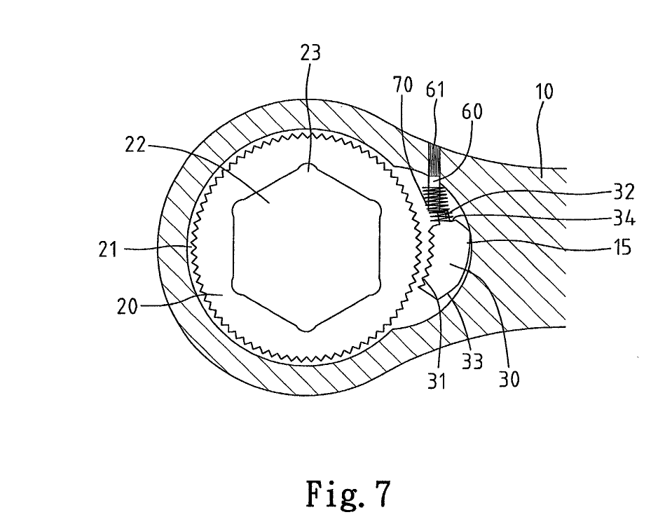

Referring to FIG. 6, in a case that the toothed side 31 of the pawl 30 is stuck to the teeth 21 of the drive member 20 due to rusting or other reasons, the pawl 30 will still be stuck to the drive member 20 when the handle 10 is turned counterclockwise. Referring to FIG. 7, when the handle 10 is further turned counterclockwise, the peg 32 on the attachment side of the pawl 30 will impinge the anchor 60. The impinging force will be large enough to disengage the pawl 30 from the drive member 20, best shown in FIG. 7. Namely, the stuck problem of the pawl 30 is solved.

It is noted that the compartment 11 of the wrench in accordance with the present invention can be processed by milling, which can be quickly achieved by computer numerical control (CNC). The overall structure of the wrench in accordance with the present invention is simple and the assembly procedure therefor is easy. The embossed end 61 of the anchor 60 allows it to be inserted into and thus retained in the transverse hole 13 without the need of threading engagement. The other end of the anchor 60 is located in the cavity 15 of the wrench and extended into a portion of the elastic element 70, which prevents malfunction of the elastic element 70 as a result of deformation. The pawl 30 and the drive member 20 are meshed with each other by a plurality of teeth to withstand a larger torque. In a case that the pawl 30 is stuck to the drive member 20 as a result of rusting or other reasons, the pawl 30 can be disengaged from the drive member 20 by means of simply turning the handle along the free rotating direction (i.e., counterclockwise in the embodiment described), which causes impingement to the pawl 30 by the anchor 60.

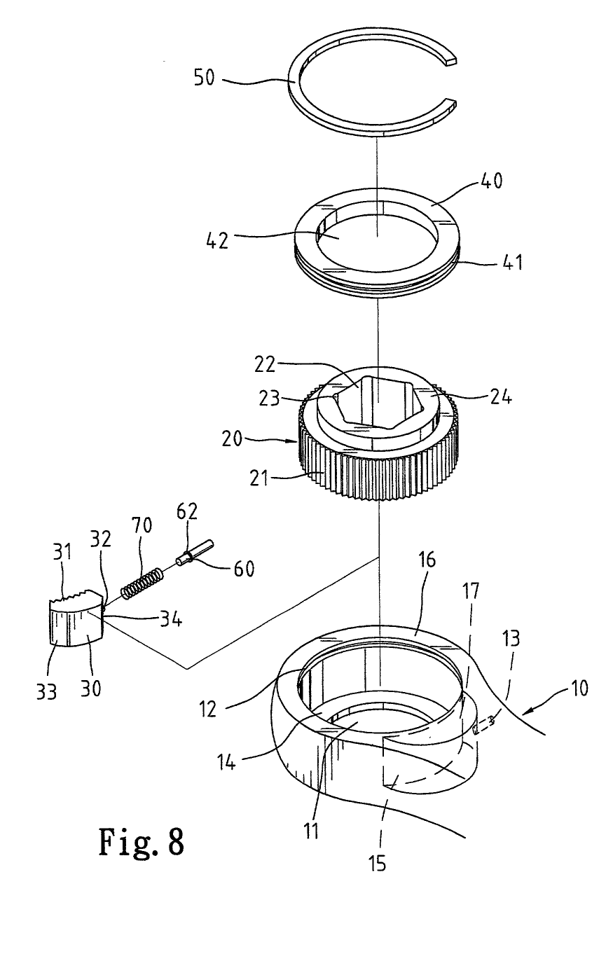

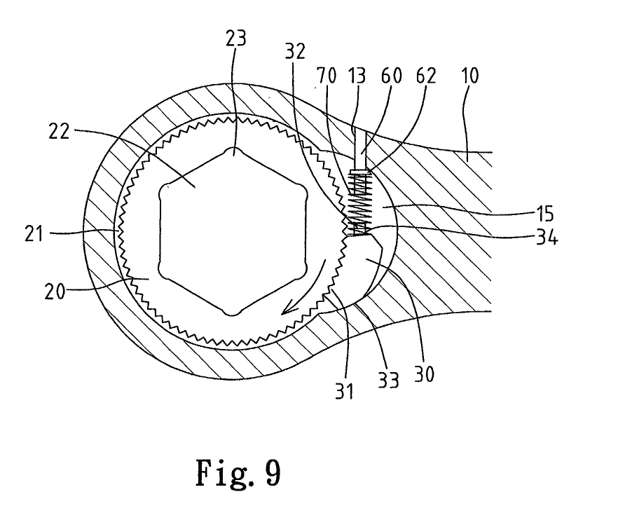

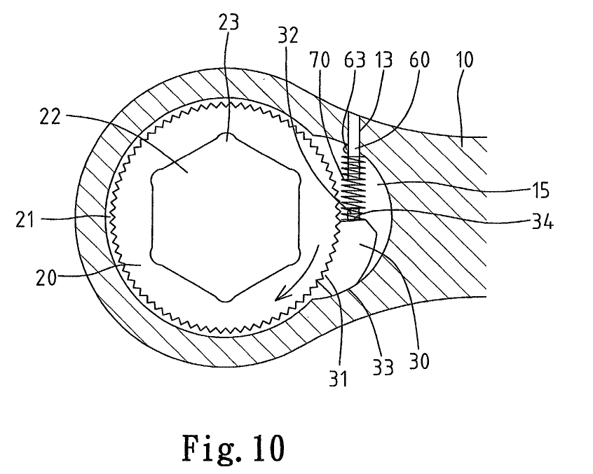

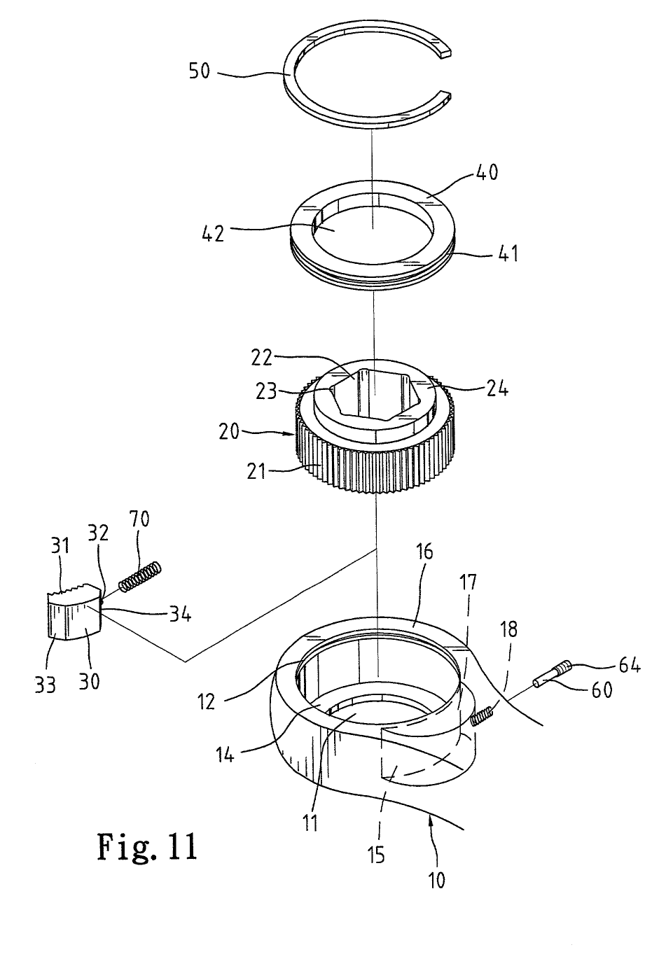

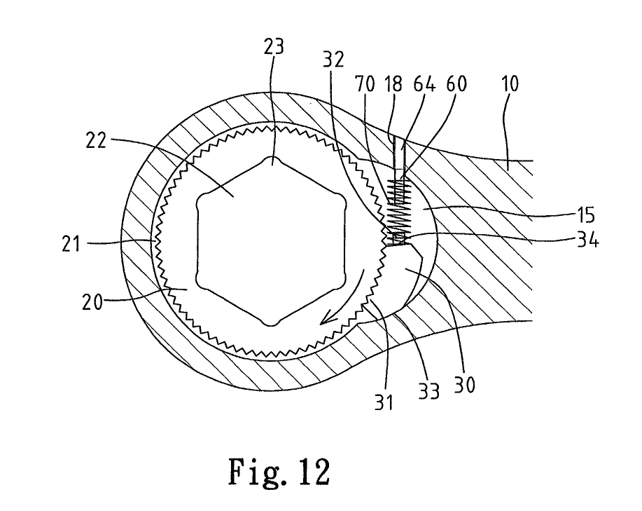

FIGS. 8 and 9 illustrate a second embodiment of the wrench in accordance with the present invention, wherein the anchor 60 includes a flange 62 on an outer periphery thereof and located in the cavity 15, and the second end of the elastic element 70 is attached to the flange 62 of the anchor 60. FIG. 10 illustrates a third embodiment of the wrench in accordance with the present invention, wherein the anchor 60 includes a protrusion 63 on an outer periphery thereof and located in the cavity 15, and the second end of the elastic element 70 is attached to the protrusion 63 of the anchor 60. FIGS. 11 and 12 illustrate a fourth embodiment of the wrench in accordance with the present invention, wherein the transverse hole (now designated by “18”) is a screw hole and the anchor 60 includes a threaded section 64 that is threadedly engaged in the screw hole 18. The second end of the elastic element 70 is also attached to the anchor 60.

The ratchet type ring spanner disclosed in U.S. Pat. No. 5,636,557 has no transverse hole that has an inner end communicated with the cavity defined in the web and an outer end communicated with outside. By contrast, the wrench in accordance with the present invention has a transverse hole 13, 18 having an inner end communicated with the cavity 15 defined in the web 17 and an outer end communicated with outside. Provision of the transverse hole 13, 18 allows easy assembly of the wrench, and the overall structure is simplified. And formation of the transverse hole 13, 18 can be easily accomplished.

Although the invention has been explained in relation to its preferred embodiments, it is to be understood that many other possible modifications and variations can be made without departing from the scope of the invention as hereinafter claimed.

What is claimed is:

1. A wrench comprising:
a handle;
a head extended from the handle and including a compartment, a web being defined between the handle and the head, a cavity being defined in the web and communicated with the compartment, a transverse hole being defined in the web and including an inner end communicated with the cavity and an outer end communicated with outside;
a drive member rotatably mounted in the compartment and including a plurality of teeth on an outer periphery thereof;
a pawl slidably mounted in the cavity and including a toothed side, an attachment side, and a pressing side;
an anchor securely mounted in the transverse hole; and
an elastic element including a first end attached to the attachment side of the pawl and a second end attached to the anchor, the pawl being biased by the elastic element such that the toothed side of the pawl is biased to engage with the teeth of the drive member and that the pressing side of the pawl is biased to press against with a wall defining the cavity.

2. The wrench as claimed in claim 1, wherein the anchor includes an embossed end for frictional engagement with an inner periphery defining the transverse hole.

3. The wrench as claimed in claim 2, wherein the attachment side of the pawl includes a peg to which the first end of the elastic element is attached.

4. The wrench as claimed in claim 3, wherein the peg is impinged by another end of the anchor when the handle is turned in a free rotating direction and thus causes disengagement of the pawl from the drive member in a case that the pawl is stuck to the drive member.

5. The wrench as claimed in claim 1, wherein the drive member includes a protruded portion on a top thereof, further comprising a ring cap mounted around the protruded portion, the ring cap including an annular groove in an outer periphery thereof, an inner periphery defining the compartment of the head including an upper portion with an annular groove, further comprising a C-clip engaged in the annular groove of the ring cap and the annular groove of the head.

6. The wrench as claimed in claim 5, wherein the inner periphery defining the compartment of the head includes an annular ledge projecting inward from a lower portion thereof.

7. The wrench as claimed in claim 1, wherein the drive member includes an inner periphery for engaging with a fastener.

8. The wrench as claimed in claim 7, wherein the inner periphery of the drive member includes a plurality of faces, each two adjacent said faces having a concave portion therebetween.

9. The wrench as claimed in claim 7, wherein the anchor includes an embossed end for frictional engagement with an inner periphery defining the transverse hole.

10. The wrench as claimed in claim 7, wherein the attachment side of the pawl includes a peg to which the first end of the elastic element is attached.

11. The wrench as claimed in claim 10, wherein the peg is impinged by another end of the anchor and thus causes disengagement of the pawl from the drive member in a case that the pawl is stuck to the drive member.

12. The wrench as claimed in claim 1, wherein the anchor includes a flange on an outer periphery thereof and located in the cavity, and wherein the second end of the elastic element is attached to the flange of the anchor.

13. The wrench as claimed in claim 1, wherein the anchor includes a protrusion on an outer periphery thereof and located in the cavity, and wherein the second end of the elastic element is attached to the protrusion of the anchor.

14. The wrench as claimed in claim 1, wherein the transverse hole is a screw hole, and wherein the anchor includes a threaded section that is threadedly engaged in the screw hole.
